(19) United States
(12) Patent Application Publication
(10) Pub. No.: US 2010/0000662 A1
(43) Pub. Date: Jan. 7, 2010

(54) METHOD FOR MANUFACTURING GREEN TIRE AND APPARATUS FOR BUILDING GREEN TIRE

(76) Inventor: Hiroyuki ONIMATSU, Kobe-shi (JP)

Correspondence Address: BIRCH STEWART KOLASCH & BIRCH, PO BOX 747, FALLS CHURCH, VA, 22040-0747, US

(21) Appl. No.: 12/435,709

(22) Filed: May 5, 2009

(30) Foreign Application Priority Data
Jul. 2, 2008 (JP) 2008-173699

(51) Int. Cl. B29D 30/32; B29D 30/24

(52) U.S. Cl. 156/132; 156/415

(57) ABSTRACT

A method and apparatus for manufacturing a green tire capable of preventing the variation of carcass-cord paths between bead cores and disturbances of the carcass cord arrangement are disclosed. An assembly of a bead core and a bead apex rubber is set on the radially outside of a cylindrical carcass assembly, and they are locked with a bead lock ring expanded, while maintain the cylindrical shape. Then, applying tension to the carcass cords between the expanded bead lock rings, the bead apex rubber is folded down towards the tire equator. Further, the edges portions of the carcass are turned up around the bead cores locked.

### BACKGROUND OF THE INVENTION

The present invention relates to a method for manufacturing a green tire and an apparatus for building a green tire capable of preventing the variation of carcass-cord paths between bead cores and disturbances of the carcass cord arrangement in order to improve the tire uniformity when manufacturing a pneumatic tire having a radial carcass ply, as shown in FIG. 12, a green tire is conventionally built as follows: First, a cylindrical carcass assembly (b) is formed by winding a strip of a row carcass ply on a cylindrical building drum (a) such that the edge portions of the strip protrude from the axial edges of the building drum (a). Then, the protruding edge portions (b2) of the cylindrical carcass assembly (b) are squeezed into a smaller diameter. Thereafter, bead core assemblies (c) are fitted on the carcass assembly (b) by moving the assemblies (c) axially inwardly from the squeezed edge portions. Then, each bead core assembly (c) is pressed against the axially outer side face of the building drum (a) through the carcass assembly (b) so that the bead core assembly (c) is adhered to the carcass assembly (b) by their self-bonding properties. In this state, the bead apex rubber (c1) of the bead core assembly (c) is folded down axially inwards. Then, the squeezed protruding edge portion (b2) is turned up around the bead core by inflating a bladder (e).

In this conventional method, however, there is a possibility that the carcass cord arrangement is disturbed and the paths of the carcass cords between the bead cores (c2) become uneven when the edge portions (b2) are squeezed, or the bead apex rubber (c1) is folded down, or the edge portions (b2) are turned up, and as a result, the tire uniformity is deteriorated.

It is therefore, an object of the present invention to provide a method and an apparatus for manufacturing a green tire, in which the carcass cord arrangement is prevented from being disturbed, and the variation of the carcass-cord paths is minimized, therefore, the tire uniformity can be improved.

According to the present invention, a method for manufacturing a green tire comprises the following steps:

a cylindrical-carcass-assembly building step in which a cylindrical carcass assembly is built on an expandable-and-contractable carcass drum;

a bead-core setting step in which a bead core assembly of a bead core and a bead apex rubber adhered to the outer circumferential surface of the bead core, is set on the radially outside of the cylindrical carcass assembly on the carcass drum at predetermined positions axially inside the both axial edges of the cylindrical carcass assembly, and then the cylindrical carcass assembly is pressure bonded to the bead core assemblies;

a cylindrical-carcass-assembly transferring step in which the cylindrical carcass assembly with the bead core assemblies is transferred to the outer circumferential surface of an expandable-and-contractable shaping drum unit;

a bead locking step in which expandable-and-contractable bead lock rings are expanded so that the cylindrical carcass assembly is clamped between the expanded bead lock rings and the bead cores of the bead core assemblies, whereby the bead core assemblies are locked on the cylindrical carcass assembly:

a carcass-cord tensioning step in which the shaping drum unit is expanded so as to cause tension in carcass cords of the cylindrical carcass assembly between the bead core assemblies locked by the bead lock rings;

a bead-core contacting step in which the bead lock rings are moved axially inwards so that the axially inner side face of the bead core of each of the bead core assemblies is pressed against an axially outer side face of the expanded shaping drum unit through the carcass assembly; and

a bead-apex-rubber fold-down step in which a bladder is inflated so that the bead apex rubber of each of the bead core assemblies is folded down by the inflated bladder and the bead apex rubber is pressure bonded to a central portion of the carcass assembly.

According to the present invention, an apparatus for building a green tire comprises:

a shaping drum machinery comprising an expandable-and-contractable shaping drum unit having a rotational axis and an outer circumferential surface for supporting a central portion of a cylindrical carcass assembly;

a bead lock disposed on each side in the axial direction of the shaping drum unit, the bead lock comprising an expandable-and-contractable bead lock ring disposed concentrically with the rotational axis of the shaping drum unit, the bead lock ring having an outer circumferential surface for supporting an inner circumferential surface of a bead core incorporated in a bead core assembly which assembly comprises the bead core and a bead apex rubber attached to an outer circumferential surface of the bead core; and

a bead-apex-rubber folding-down device comprising an inflatable bladder,

wherein

when the bead core assembly is placed on each side in the axial direction of the shaping drum unit and on the radially outside of the cylindrical carcass assembly set on the outer circumferential surface of the shaping drum unit, said bead lock can expand the bead lock ring to clamp the cylindrical carcass assembly between the bead core assembly and the outer circumferential surface of the bead lock ring;

after the cylindrical carcass assembly is clamped, the shaping drum machinery can expand the shaping drum unit to radially outwardly swell a central portion of the cylindrical carcass assembly between the bead core assemblies and to cause tension in carcass cords in the central portion, wherein the shaping drum unit expands radially outwardly beyond the inner circumferential surface of the bead cores so that an axially outer side face appears on each side of the shaping drum unit, and

the bead lock can move the bead lock ring axially inwards to approach the expanded shaping drum unit and to press the axially inner side face of the bead core of the locked bead core assembly against the axially outer side face of the expanded shaping drum unit through the swelled carcass assembly; and

after the bead core is pressed, the bead-apex-rubber folding-down device can inflate the bladder to fold down the bead apex rubber of the bead core assembly so that the bead apex rubber adheres to the central portion of the swelled carcass assembly.

In the present invention, in order to set the bead core assemblies on the outside of the cylindrical carcass assembly, instead of squeezing the edge portions of the cylindrical carcass assembly, the entirely of the cylindrical carcass assembly is first formed to have an outer diameter slightly smaller than the inner diameter of the bead cores. Then, the carcass assembly is pressure bonded to the bead core assemblies while the carcass assembly is maintained in a cylindrical shape on the carcass drum. Accordingly, the carcass-cord paths between the bead cores are fixed in this stage. Further, the bead core assemblies and the cylindrical carcass assembly are locked with the expand bead lock rings. Thereafter, the bead apex rubber is folded down, and the edge portions of the cylindrical carcass assembly are turned up. In other words, the operations which cause a large deformation or motion on the carcass cords are carried out after the carcass cords are tightly locked. Accordingly, the variation of the carcass-cord paths is minimized, and the disturbance of the carcass cord arrangement is prevented. Therefore, the tire uniformity can be improved.

### BRIEF DESCRIPTION OF THE DRAWINGS

FIG. 1 is a schematic plan view showing a part of a production system for a pneumatic tire in which an apparatus for building a green tire according to the present invention is incorporated.

FIG. 2 is a schematic side view showing a first transfer equipment thereof.

FIG. 3 is a schematic side view showing a cylindrical-carcass-assembly holding device and a bead-core-assembly holding device incorporated in the first transfer equipment.

FIG. 4 is a schematic side view showing another example of the cylindrical-carcass-assembly holding device is a cross sectional view of the apparatus for building a green tire according to the present invention.

FIG. 5 is an enlarged partial cross sectional view thereof.

FIG. 6 is a cross sectional view showing the bead locking step of a method for manufacturing a green tire according to the present invention.

FIG. 7 is a cross sectional view showing the carcass-cord tensioning step of the method is a cross sectional view showing the bead-core contacting step of the method.

FIGS. 10(A), 10(B) and 10(C) are cross sectional views showing the bead-apex-rubber fold-down step of the method.

FIG. 11 is a schematic cross sectional view of the shaping drum taken perpendicularly to the axial direction of the drum.

FIG. 12 is a diagram for explaining the prior art method for manufacturing a green tire.

### DESCRIPTION OF THE PREFERRED EMBODIMENTS

Embodiments of the present invention will now be described in detail in conjunction with accompanying drawings.

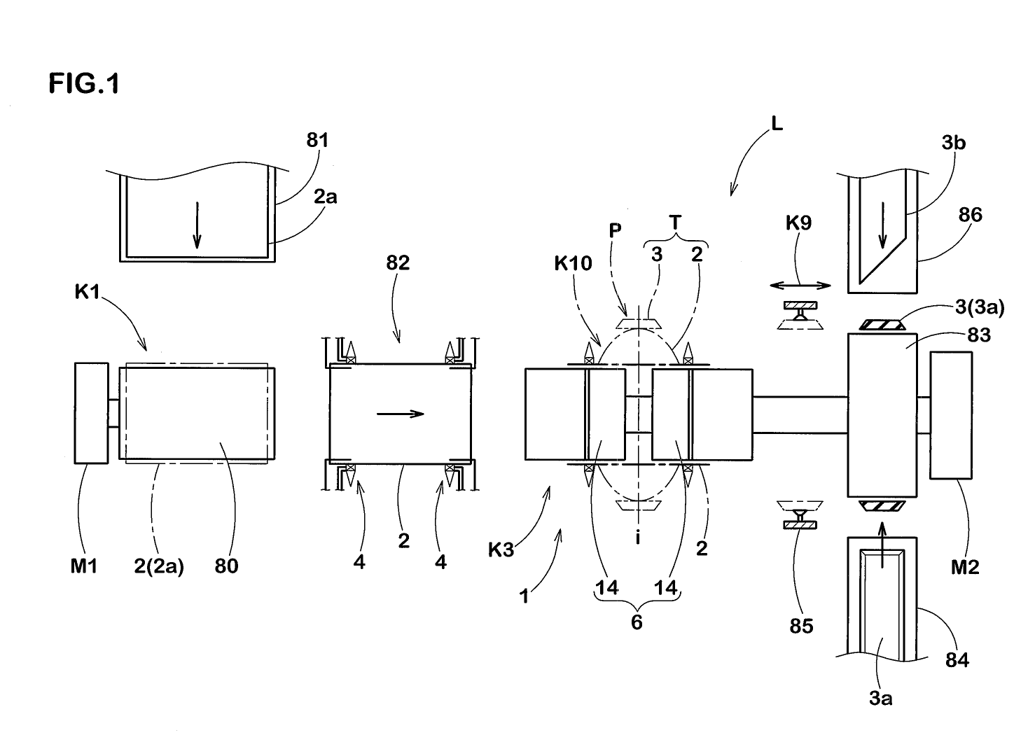

FIG. 1 is a schematic plan view showing a part of a production system for a pneumatic tire in which an apparatus L for building a green tire 1 according to the present invention is incorporated. This production system further comprises:

an expandable-and-contractable carcass drum 80,

a supplying equipment 81,

a first transfer equipment 82,

an expandable-and-contractable belt drum 83,

a supplying equipment 84,

a second transfer equipment 85, and

a supplying equipment 86.

The carcass drum 80 is rotatable by an electric motor Ml and used to build a carcass assembly 2.

The supplying equipment 81 supplies raw materials to the carcass drum 80, and the raw materials are wound on the outer circumferential surface of the carcass drum 80 to form the carcass assembly 2 having a cylindrical shape. The raw materials include at least a strip of a carcass ply 2a. Further, the raw materials can include a strip of innerliner rubber, a strip of sidewall rubber, a strip of chafer rubber and the like for example.

The first transfer equipment 82 receives the carcass assembly 2 took out from the carcass drum 80 and conveys to the green-tire-building apparatus L.

The belt drum 83 is rotatable by an electric motor M2 and used to build a tread ring 3.

The supplying equipment 84 supplies a raw tread rubber 3a to the belt drum 83.

The supplying equipment 86 supplies a raw tread reinforcing ply 3b such as belt ply to the belt drum 83. The raw tread reinforcing ply and tread rubber 3a supplied are wound on the outer circumferential surface of the belt drum 83 to form the cylindrical tread ring 3.

The second transfer equipment 85 receives the tread ring 3 took out from the belt drum 83 and conveys to a waiting position P where the tread ring 3 is centered on the widthwise center (i) of the shaping drum unit 6 of the green-tire-building apparatus L.

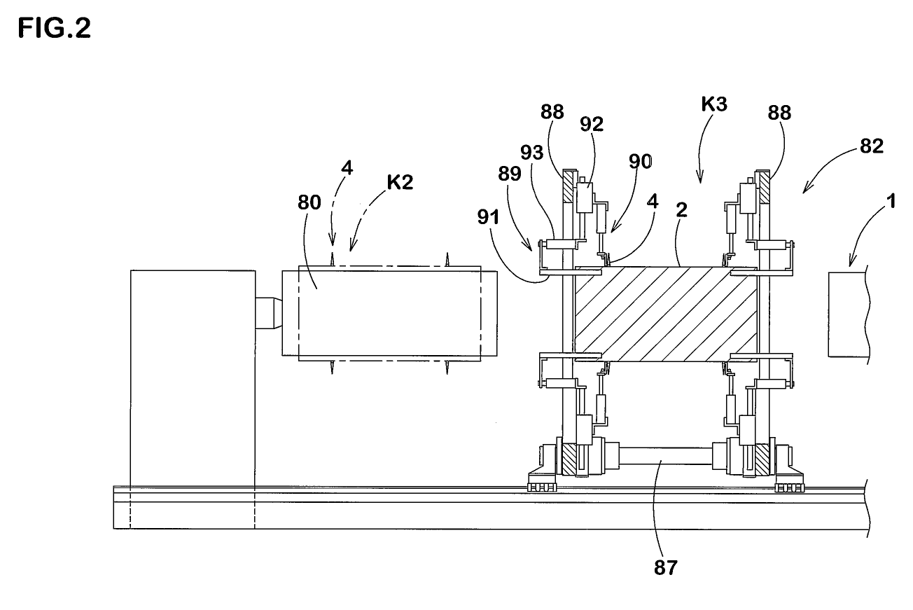

As shown in FIG. 2, the first transfer equipment 82 comprises:
a base frame 87 supported by guide rails movably between the carcass drum 80 and the green-tire-building apparatus L;
a pair of ring-shaped annular frames 88 which are concentric with the carcass drum 80 and disposed uprightly on the moving base frame 87;
a cylindrical-carcass-assembly holding device 89 disposed on each of the annular frames 88; and
a bead-core-assembly holding device 90 disposed on each of the annular frames 88.

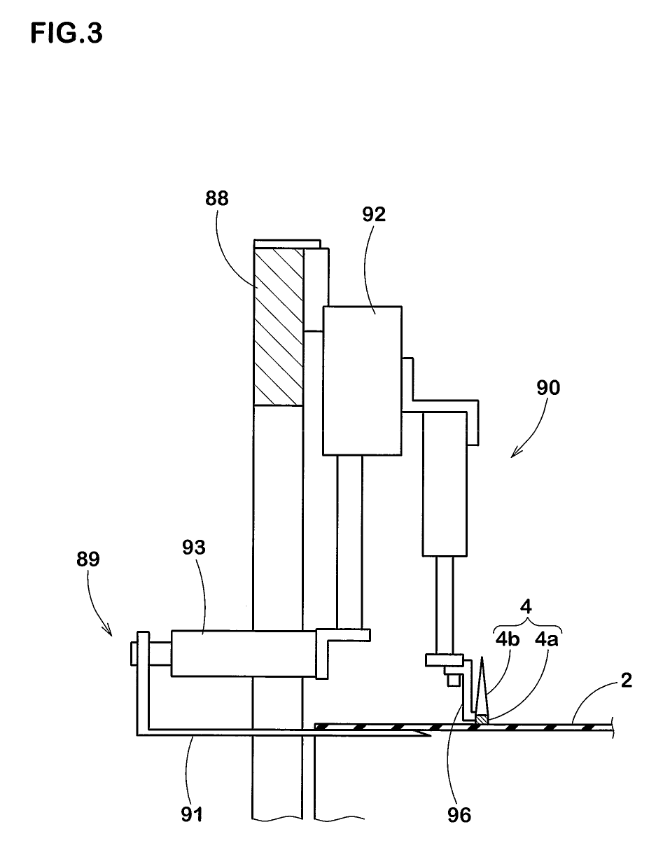

As shown in FIG. 3, each of the cylindrical-carcass-assembly holding devices 89 comprises:
a plurality of paddles 91 disposed on a circle concentric with the rotational axis of the carcass drum 80 at regular intervals:
a radial mover 92 which is a linear actuator such as cylinder or the like; and
a lateral mover 93 which is a linear actuator such as cylinder or the like.

Each of the paddles 91 is supported movably in the radial direction outwards and inwards by the radial mover 92 and movably in the axial direction outwards and inwards by the lateral mover 93. Thus, the paddles 91 can be inserted between the carcass drum 80 and the cylindrical carcass assembly 2 wound on the carcass drum 80 in order to receive the carcass assembly 2 from the carcass drum 80.

Each of the bead-core-assembly holding devices 90 comprises: a plurality of bead-lateral-side holding devices 96 disposed on a circle concentric with the rotational axis of the carcass drum 80 at regular intervals.

Here, the bead core assembly 4 is a ring made up of the bead core 4a formed by winding a steel wire, and a bead apex rubber 4b of a triangular cross-sectional shape adhered to the outer circumferential surface of the bead core 4a. The bead core assembly 4 is formed beforehand in another process and supplied to the first transfer equipment 82 with the use of a supplying equipment (not shown).

Each of the bead-lateral-side holding devices 96 comprises a magnet attracting the bead core 4a of the bead core assembly 4 and holding it on a side face thereof.

In this embodiment, by the use of the first transfer equipment 82, two bead core assemblies 4 are set on the radially outside of the cylindrical carcass assembly 2 wound on the carcass drum 80 at predetermined positions.

Then, the carcass drum 80 is expanded in order to press the cylindrical carcass assembly 2 against the inside of the bead core assemblies 4, whereby they are pressure bonded.

Thus, the carcass-cord paths between the bead cores 4a is determined in this stage.

Next, the carcass drum 80 is contracted, and the paddles 91 are inserted between the cylindrical carcass assembly 2 and carcass drum 80. Thus, the cylindrical carcass assembly 2 with the bead core assemblies 4 can be took out from the carcass drum 80 and received by the first transfer equipment 82.

The first transfer equipment 82 can convey the took-out assemblies 2 and 4 to the green-tire-building apparatus L, while maintaining the cylindrical state.

During receiving and transferring of the carcass assembly 2 by the first transfer equipment 82, the bead-core-assembly holding device 90 can always support the bead core assembly 4, therefore, a displacement of the bead core assembly 4 from the carcass assembly 2 can be prevented.

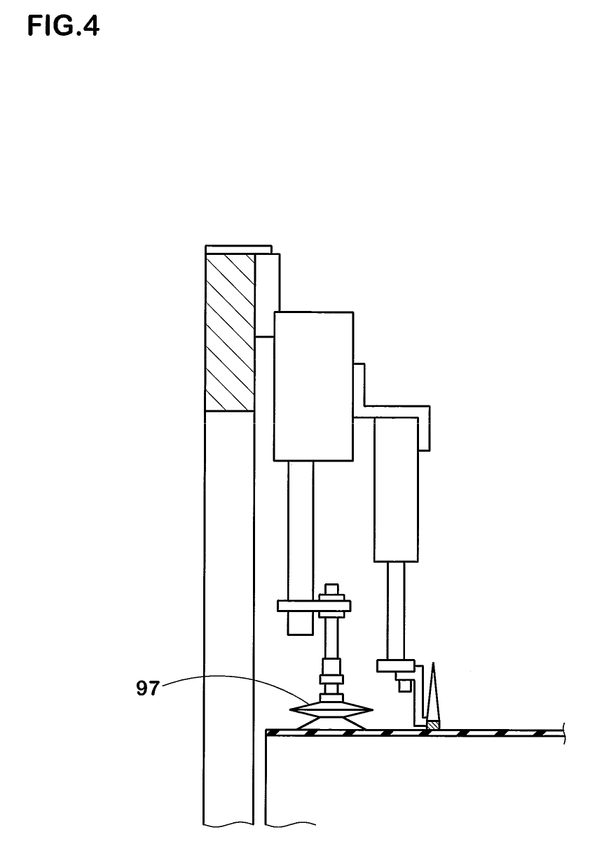

As a modification of the first transfer equipment 82, a vacuum pad 97 can be used instead of the paddle 91 as shown in FIG. 4. Further, it is also possible to use the lifting paddle 91 and vacuum pad 97 in combination.

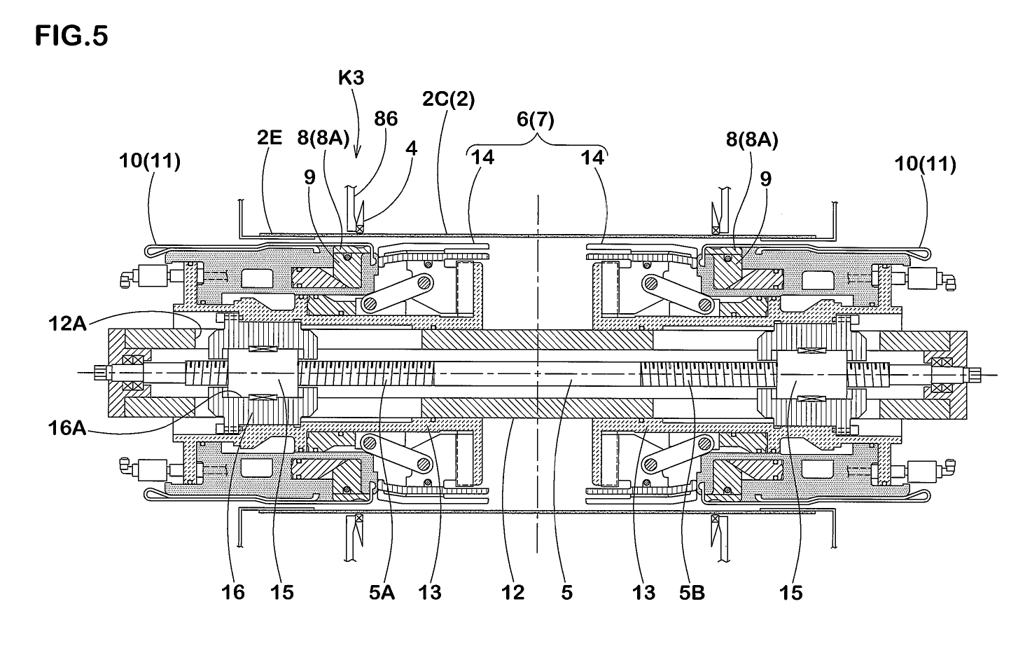

As shown in FIG. 5, the green-tire-buil-ding apparatus L comprises: a shaping drum machinery 7, a pair of bead locks 9, and a pair of bead-apex-rubber folding-down devices 11.

The shaping drum machinery 7 comprises:
a drum shaft 5 both end portions of which are supported rotatably;
a tubular body 12 disposed on the radially outside of the drum shaft 5 concentrically with the drum shaft 5; and
an expandable-and-contractable shaping drum unit 6 supported rotatably and comprising a pair of right and left drums 14 for supporting the cylindrical carcass assembly 2.

The drum shaft 5 is a threaded shaft provided with a right-hand thread and a left-hand thread to form a right-hand thread part 5A and a left-hand thread part 5B. To the thread parts 5A and 5B, screw nuts 15 are engaged respectively one end of the drum shaft 5 is coupled with a first driving motor (not shown) to axially move the first axially-slidable tubular bodies 13 in the opposite directions as hereinafter described.

The tubular body 12 has almost same length as the drum shaft 5 and is provided on each side of the center in the longitudinal direction with a guiding hole 12A longer in the axial direction.

The tubular body 12 is supported by the drum shaft 5 through the intermediary of bearing units, therefore, the tubular body 12 is rotatable independently from the drum shaft 5.

On each side of the center in the longitudinal direction of the tubular body 12, a first axially-slidable tubular body 13 is slidably set on the outer circumferential surface of the tubular body 12.

One end of the tubular body 12 is coupled with a second driving motor (not shown) to rotate the tubular body 12 together with the first axially-slidable tubular bodies 13.

In each of the guiding holes 12A, a mover 16 is disposed movably in the axial direction, guided by the guiding hole 12A.

The mover 16 has a radially outer portion protruding radially outwardly from the guiding hole 12A and bolted to an axially outer end portion of one of the first axially-slidable tubular bodies 13.

Further, the mover 16 has a radially inner portion 16A concaved and engaged with the screw nut 15 so that relative rotational motions therebetween are allowed, but relative axial motions therebetween are not allowed.

Accordingly, the tubular body 12 can be rotated by the second driving motor, while maintaining the axial position of each mover 16.

Therefore, upon the rotation of the drum shaft 5 by the first driving motor, through the intermediary of the screw nuts 15 and movers 16, both of the first axially-slidable tubular bodies 13 can be moved simultaneously in the axial direction toward or away from the widthwise center (i) of the shaping drum unit 6.

The right and left drums 14 are mounted on the right and left first axially-slidable tubular bodies 13, respectively. The mount position of each of the drum 14 is in the axially inner end portion of the tubular body 13 on the axially inside of the mover 16.

Each of the right and left drums 14 comprises:
a plurality of circumferentially divided segments 20;
a radial guide support 21 supporting the segments 20 movably in the radial direction; and
a first expanding/contracting device 24.

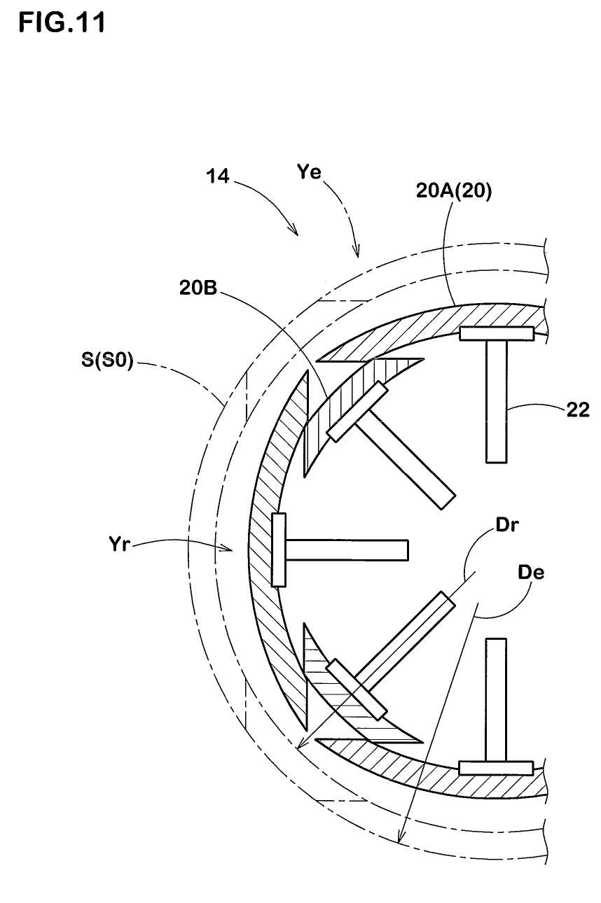

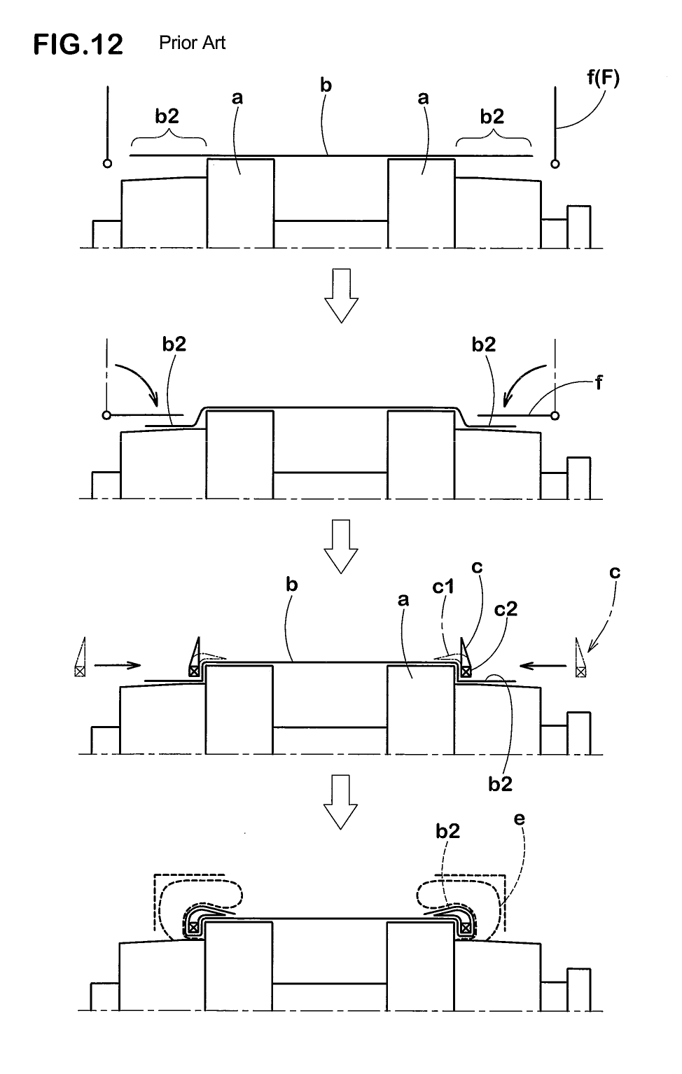

The segments 20 include first segments 20A and second segments 20B which are disposed alternately in the circumferential direction. In this example, as shown in FIG. 11, the first segment 20A is larger in the circumferential size than the second segment 20B. The segments 20A and 20B are each provided on the radially inside thereof with a mounting plate 22 which is positioned at the circumferential center of the segment and extends radially inward.

In the expanded state Ye, the first and second segments 20A and 20B are arranged side by side in the circumferential direction so that their outer surfaces s collectively form a cylindrical surface S0 substantially continuous in the circumferential direction.

In the contracted state Yr, on the other hand, both of the first and second segments 20A and 20B are retracted radially inwards, wherein the second segments 20B are retracted more than the first segments 20A.

The diameter De of the drum 14 in the expanded state Ye is more than the outer diameter of the bead core 4a. The diameter Dr of the drum 14 in the contracted state Yr is less than the inner diameter of the cylindrical carcass assembly 2.

The radial guide support 21 comprises:
a circular side plate 23 disposed at the axially inner end of the first axially-slidable tubular body 13, and
a plurality of radial guides 23A provided on the axially inner side face of the side plate 23 at intervals in the circumferential direction.

Each of the radial guides 23A comprises a guide groove, a guide rail or the like to guide one of the side edges of one of the mounting plates 22 inwardly or outwardly in the radial direction.

The first expanding/contracting device 24 comprises: an annular piston chamber 25 formed concentrically with the first axially-slidable tubular body 13 and extending in the axial direction;
a ring-shaped piston 26 fitted in the piston chamber 25 slidably in the axial direction, and driven by a high-pressure air supplied into the piston chamber 25; and
a plurality of links 27 each extending radially and having one end portion pivotally attached to the axially inner end portion of the piston 26 and the other end portion pivotally attached to the mounting plate 22 of one of the segments 20, wherein the links 27 include
longer links pivotally engaged with the second segments 20B having a longer radial travel distance, and
shorter links pivotally engaged with the first segments 20A having a shorter radial travel distance.

In order to bias the segments 20 toward the radially inside, the segments 20 are each provided with a return spring 95.

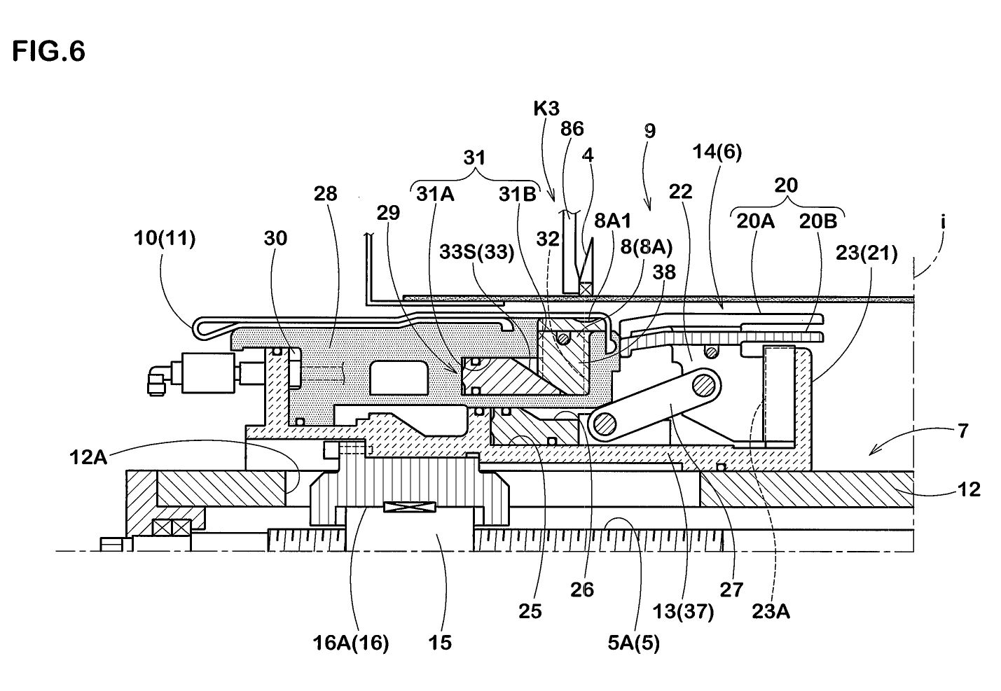

As shown in FIG. 6, each of the right and left bead locks 9 comprises:
a second axially-slidable tubular body 28 fitted on the radially outside of the first axially-slidable tubular body 13 slidably in the axial direction;
a second expanding/contracting device 29: and
an expandable-and-contractable bead lock ring 8 supported by the second axially-slidable tubular body 28 through the intermediary of the second expanding/contracting device 29.

The bead lock ring 8 is made up of a plurality of circumferentially divided segments 8A, and positioned on the axially outside of one of the axial edges of the shaping drum unit 6.

In order to catch the inner circumferential surface of the bead core 4a, the segments 8A are each provided at the radially outer end thereof with a core support surface 8A1 which is curved concavely like the surface of a groove.

The second axially-slidable tubular body 28 forms an airtight air chamber 30 between the axially outer end of the second axially-slidable tubular body 28 and a radially extending wall of the first axially-slidable tubular body 13.

Therefore, by supplying a high-pressure air into the air chamber 30, the second axially-slidable tubular body 28 is moved axial inwards.

The second axially-slidable tubular body 28 has a piston chamber 31 on the axially inside of the air chamber 30.

The piston chamber 31 comprises:
an annular lateral piston room 31A formed in its axially inner end portion concentrically with the second axially-slidable tubular body 28; and
an annular radial piston room 31B extending radially outwardly from the axially inner end portion of the lateral piston room 31A. Thus, in a half cross section as shown in FIG. 6, the piston chamber 31 is L-shaped.

In the radial piston room 31B, a plurality of radial guide supports 38 are disposed.

Each of the radial guide supports 38 is guided in the radial direction by a linear guide 32 such as guide groove, guide rail or the like provided on sidewall faces of the radial piston room 31B.

The radially outer end of each of the radial guide supports 38 is fixed to one of the segments 8A.

The segments 8A are each provided with a return spring 94 for biasing towards the radial inside.

In the lateral piston room 31A, an annular piston 33 is disposed.

The annular piston 33 is provided in the axially inner end portion thereof with a tapered surface 33S inclined radially inside towards the axial inside.

By supplying a high-pressure air into the lateral piston room 31A on the axially outside of the piston 33, the piston 33 can slide inside in the axial direction.

During sliding, the tapered surface 33S, always contacts with a tapered surface of the radially inner end portion of each of the radial guide supports 38.

Therefore, all of the radial guide supports 38 are moved radial inwards or outwards together with the segment 8A.

In this example, the piston chamber 31, piston 33 and radial guide supports 38 constitute the second expanding/contracting device 29 for expanding or contracting the bead lock ring 8.

Each of the bead-apex-rubber folding-down devices 11 comprises:
an inflatable bladder 10 mounted on the second axially-slidable tubular body 28; and
a pressure plate 34 surrounding the bladder 10.

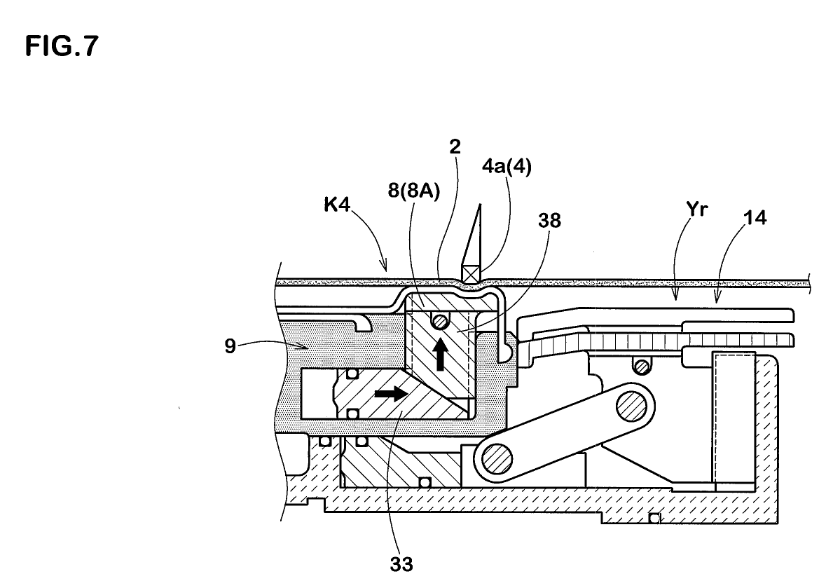

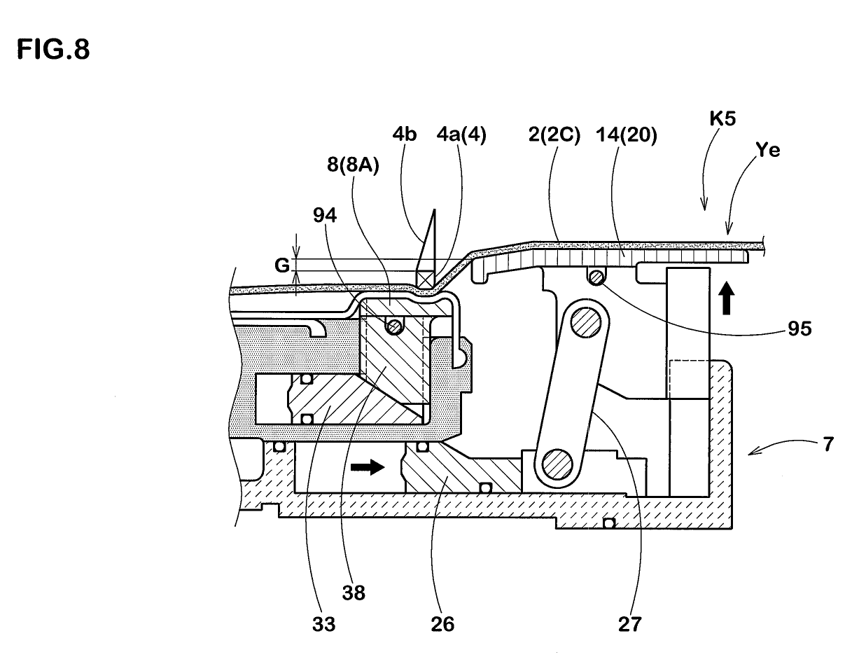

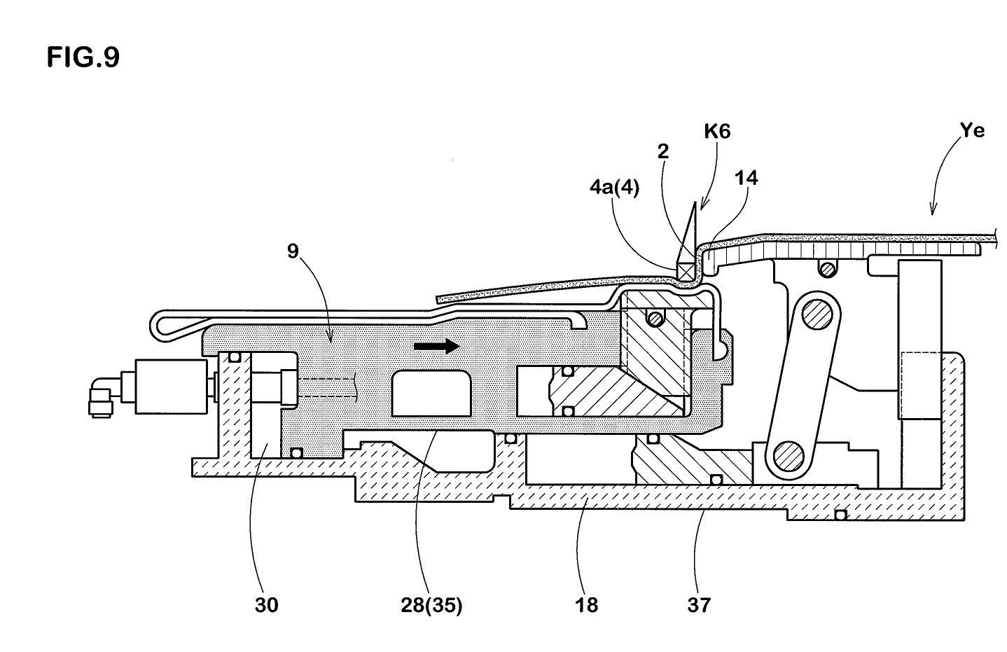

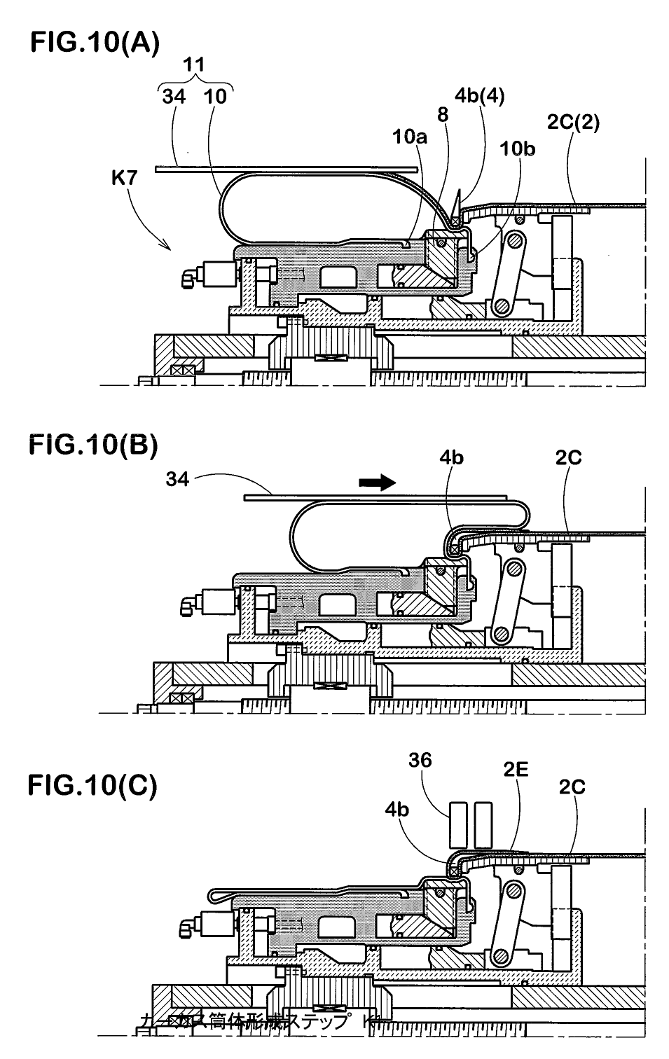

In the normal state of the bladder 10, the bladder 10 is deflated and folded on the outer circumferential surface of the second axially-slidable tubular body 28 as shown in FIGS. 6-8. As best shown in FIGS. 10(A)-10(C), the circular edge 10a of one opening of the bladder 10 is fixed to the tubular body 28 at a position on the axially outside of the bead lock ring 8. The circular edge 10b of the other opening of the bladder 10 is fixed to the tubular body 28 at a position on the axially inside of the bead lock ring 8.

The pressure plate 34 can be a continuous annular plate or a plurality of circumferentially arranged pieces.

The pressure plate 34 can contact with the inflated bladder 10 as shown in FIG. 10(A).

The pressure plate 34 can move axially inside, therefore, as shown in FIG. 10(B), the inflated bladder 10 is deformed towards the axial inside so that the deformed bladder 10 folds down the bead apex rubber 4b toward the axially inside.

The green-tire-building apparatus L is able to: lock the bead portions of the cylindrical carcass assembly 2 with the bead core assemblies 4;
inflate a central portion 2C of the cylindrical carcass assembly 2 between the bead core assemblies 4 into a troidal shape; and
turn up the edge portions of the cylindrical carcass assembly 2; fold down the bead apex rubber 4b.

In this example, since the bead lock ring 8 is supported by the first axially-slidable tubular body 13 constituting the shaping drum machinery 7, the bead lock ring 8 moves together with the drum 14 in the axial direction. Therefore, even if the drum 14 is moved in the axial direction, it is possible to maintain the above-mentioned locked state in which the bead core 4a and drum 14 contact each other through the carcass assembly 2. Thus, the first axially-slidable tubular body 13 can be said a second lateral moving mean 37 which causes to move the bead lock ring 8 (bead lock 9) to accompany the axial movement of the drum 14.

Next, a method for manufacturing a green tire by the use of the green-tire-building apparatus L according to the present invention will be explained.

In this embodiment, the method comprises:

a cylindrical-carcass-assembly building step K1,

a bead-core setting step K2,

a cylindrical-carcass-assembly transferring step K3,

a bead locking step K4,

a carcass-cord tensioning step K5,

a bead-core contacting step K6,

a bead-apex-rubber fold-down step K7,

a sidewall-rubber winding step K8,

a tread-ring transferring step K9, and

a subsequent carcass inflating and tread forming step K10.

In the cylindrical-carcass-assembly building step K1, as shown in FIG. 1, the cylindrical carcass assembly 2 is formed on the outer circumferential surface of the carcass drum 80 by winding the strips including a strip of the carcass ply 2a on the carcass drum 80.

In the bead-core setting step K2, the two bead core assemblies 4 are set on the radially outside of the cylindrical carcass assembly 2 wound on the carcass drum 80 at the predetermined positions, and the bead core assemblies 4 are pressure bonded to the cylindrical carcass assembly 2.

In this embodiment, the bead core assemblies 4 are set in place by the use of the first transfer equipment 82.

Thereafter, the carcass drum 80 is expanded together with the cylindrical carcass assembly 2 thereon so that the radially outer surface of the cylindrical carcass assembly 2 is pressure bonded to the bead core assemblies 4.

Instead of expanding the carcass drum 80, it may be also possible to use the lifting paddles 91 or vacuum pads 97. More specifically, since the cylindrical carcass assembly 2 wound on the carcass drum 80 can be expanded by moving the lifting paddles 91 or vacuum pads 97 radially outwards, the carcass assembly 2 may be pressure bonded to the bead core assemblies 4 by utilizing such expansion.

In the cylindrical-carcass-assembly transferring step K3, in order to remove the bead core assemblies 4, the carcass drum 80 is contracted. By the use of the first transfer equipment 82, the cylindrical carcass assembly 2 with the bead core assemblies 4 is took out from the carcass drum 80 and conveyed axially to the radially outer side of the shaping drum unit 6 contracted, while maintaining the cylindrical shape.

In the bead locking step K4, the bead lock rings 8 are expanded in order to clamp the cylindrical carcass assembly 2 between the bead lock rings 8 and the bead core assemblies 4. The expand of the bead lock ring 8 is possible by the radially outward movements of the segments 8A accompanying the axially inward movement of the piston 33 as explained above.

Thus, the bead core assemblies 4 are locked together with the cylindrical carcass assembly 2.

As explained, at the stage when the carcass assembly 2 has the almost right-circular cylindrical shape, the bead core assemblies 4 are pressure bonded to the carcass assembly 2, and the carcass-cord paths between the bead cores 4a is fixed. Accordingly, the variation of the carcass-cord paths can be minimized.

Through the bead locking step K4, the bead core assemblies 4 are fixed to the carcass assembly 2 in the cylindrical shape (not squeezed and not turned up). Therefore, in the subsequent steps, the occurrence of the displacement between the bead core assemblies 4 and the carcass assembly 2 can be effectively prevented, and further, the variation of the carcass-cord paths can be minimized.

In the carcass-cord tensioning step K5, as shown in FIG. 8, the right and left drums 14 of the shaping drum machinery 7 are expanded radially outward so as to cause tension in the carcass cords in the central portion 2C of the carcass assembly 2 between the bead core assemblies 4 locked by the bead lock rings 8, whereby a step G in the radial direction is formed between the outer circumferential surface of the bead core 4a and the outer circumferential surface of the drum 14, while maintaining the even arrangement of the carcass cords.

As shown in FIG. 9, it is preferable that the drum 14 is expanded such that, at the position of the bead apex rubber, the outer diameter of the carcass assembly 2 is slightly (about 5 mm to 10 mm) larger than the outer diameter of the bead core 4a. As explained above, the drum 14 can expand by the radially outward motion of the segments 20 accompanying the axially inward motion of the piston 26 through the intermediary of the links 27.

By the formation of such radial step G, it becomes possible to contact the bead apex rubber 4b to the carcass assembly 2 by folding down the bead apex rubber 4b axially inwards. To facilitate the folding-down and close contact of the bead apex rubber with the carcass assembly, it is preferable that the outer surface of the axially outer edge portion of the drum 4 is slightly tapered towards the bead core assembly 4 namely bead lock ring 8.

Incidentally, in order to obtain the above-mentioned expansion amount, if need be, the distance between the right and left drums 14 can be decreased.

In the bead-core contacting step K6, as shown in FIG. 9, the bead lock ring 8 of each of the bead locks 9 is moved axially inwards so that the axially inner side face of the bead core 4a of the bead core assembly 4 locked by the bead lock ring 8 is pressed against the axially outer side face of the drum 14 in the expanded state Ye through the carcass assembly 2. If the bead-core contacting step K6 is omitted, the inner side face of the bead core assembly 4 can not be adhered tightly to the cylindrical carcass assembly. Further, it becomes difficult to fold down the bead apex rubber 4b stably and readily with accuracy.

The bead lock ring 8 can be moved by moving the second axially-slidable tubular body 28 relatively to the first axially-slidable tubular body 13 by supplying a high-pressure air to the air chamber 30 as explained above.

In this embodiment, therefore, the second axially-slidable tubular body 28 is a first lateral moving mean 35 which moves the bead lock ring 8 axially towards the drum 14 to press the axially inner side face of the bead core 4a against the axially outer side face of the drum 14 through the carcass assembly 2. The bead lock 9 includes the first lateral moving mean 35.

In the bead-apex-rubber fold-down step K7, as shown in FIGS. 10(A) to 10(C), by the inflation of the bladder 10, the bead apex rubber 4b is folded down and pressure bonded to the central portion 2C of the carcass assembly 2.

In this embodiment, before the bladder 10 is inflated, the pressure plate 34 is moved radially outside the bladder 10. After the bladder 10 is inflated, the pressure plate 34 is moved axially inwards to press or deform the inflated bladder 10 axially inwards. Therefore, the bladder can folds down the bead apex rubber 4b and at the same time can turn up the carcass ply edge.

As shown in FIG. 10(C), by the use of pressure rollers 36, the folded-down bead apex rubber 4b and the turned-up portion 2E of the carcass assembly 2 are pressed against the central portion 2C of the carcass assembly 2. Thus, they are tightly adhered to each other.

In the sidewall-rubber winding step K8, a strip of sidewall rubber is wound on the radially outside of the carcass assembly 2, overlapping each of the turned up edge portions of the carcass assembly 2.

In the tread-ring transferring step K9, as shown in FIG. 1, by the use of the second transfer equipment 85, the tread ring 3 formed by the use of the belt drum 83 is conveyed to a position P centered on the shaping drum unit 6.

In the carcass inflating and tread forming step K10, the right and left bead lock rings 8 are moved to get close to each other, while maintaining the locked state that the bead cores 4a and drums 14 contact each other through the carcass assembly 2, and the carcass assembly between the bead lock rings 8 is inflated into a troidal shape so that the crown portion of the troidal carcass assembly 2 is pressure bonded to the radially inside of the tread ring 3 at the position P.

Therefore, the green tire T having the tread portion is formed. In this step, it is possible to use a stitch roller or the like, in order to press the entire width of the tread ring 3 against the carcass assembly 2 to ensure the pressure bonding therebetween.

In the next step K11, the bead lock rings 8 are contracted. By exhausting the high-pressure air in the lateral piston room 31A, the bead lock ring 8 can be contracted by the aid of the resilience of the return spring 94.

Thereafter, the green tire T is detached from the green-tire-building apparatus L.

The green tire T is put in a mold, and vulcanized by applying heat and pressure from the inside and outside of the tire. Therefore, a pneumatic tire is manufactured.

1. A method for manufacturing a green tire comprising the following steps:
a cylindrical-carcass-assembly building step in which a cylindrical carcass assembly is built on an expandable-and-contractable carcass drum;
a bead-core setting step in which a bead core assembly of a bead core and a bead apex rubber adhered to the outer circumferential surface of the bead core, is set on the radially outside of the cylindrical carcass assembly on the carcass-drum at predetermined positions axially inside the both axial edges of the cylindrical carcass assembly, and then the cylindrical carcass assembly is pressure bonded to the bead core assemblies;
a cylindrical-carcass-assembly transferring step in which the cylindrical carcass assembly with the bead core assemblies is transferred to the outer circumferential surface of an expandable-and-contractable shaping drum unit;
a bead locking step in which expandable-and-contractable bead lock rings are expanded so that the cylindrical carcass assembly is clamped between the expanded bead lock rings and the bead cores of the bead core assemblies, whereby the bead core assemblies are locked on the cylindrical carcass assembly:
a carcass-cord tensioning step in which the shaping drum unit is expanded so as to cause tension in carcass cords of the cylindrical carcass assembly between the bead core assemblies locked by the bead lock rings;
a bead-core contacting step in which the bead lock rings are moved axially inwards so that the axially inner side face of the bead core of each of the bead core assemblies is pressed against an axially outer side face of the expanded shaping drum unit through the carcass assembly;
a bead-apex-rubber fold-down step in which a bladder is inflated so that the bead apex rubber of each of the bead core assemblies is folded down by the inflated bladder and the bead apex rubber is pressure bonded to a central portion of the carcass assembly.

2. The method for manufacturing a green tire according to claim 1, wherein
the shaping drum unit comprises a pair of drums movable in the axial direction so as to get close to each other or away from each other, and
the bead lock rings are moved together with the respective drums,
the method further comprises a carcass inflating step in which the bead lock rings are moved to get close to each other, while maintaining the state in which the axially inner side face of each of the bead cores contacts with the axially outer side face of the shaping drum unit through the carcass assembly in the bead-core contacting step, and the carcass assembly between the bead lock rings is inflated into a troidal shape.

3. An apparatus for building a green tire comprising:
a shaping drum machinery comprising an expandable-and-contractable shaping drum unit having a rotational axis and an outer circumferential surface for supporting a central portion of a cylindrical carcass assembly;
a bead lock disposed on each side in the axial direction of the shaping drum unit,
the bead lock comprising an expandable-and-contractable bead lock ring disposed concentrically with the rotational axis of the shaping drum unit,
the bead lock ring having an outer circumferential surface for supporting an inner circumferential surface of a bead core incorporated in a bead core assembly which assembly comprises the bead core and a bead apex rubber attached to an outer circumferential surface of the bead core; and
a bead-apex-rubber folding-down device comprising an inflatable bladder, wherein
when the bead core assembly is placed on each side in the axial direction of the shaping drum unit and on the radially outside of the cylindrical carcass assembly set on the outer circumferential surface of the shaping drum unit,
said bead lock can expand the bead lock ring to clamp the cylindrical carcass assembly between the bead core assembly and the outer circumferential surface of the bead lock ring;
after the cylindrical carcass assembly is clamped, the shaping drum machinery can expand the shaping drum unit to radially outwardly swell a central portion of the cylindrical carcass assembly between the bead core assemblies and to cause tension in carcass cords in the central portion,
wherein the shaping drum unit expands radially outwardly beyond the inner circumferential surface of the bead cores so that an axially outer side face appears on each side of the shaping drum unit, and
the bead lock can move the bead lock ring axially inwards to approach the expanded shaping drum unit and to press the axially inner side face of the bead core of the locked bead core assembly against the axially outer side face of the expanded shaping drum unit through the swelled carcass assembly;
after the bead core is pressed,
the bead-apex-rubber folding-down device can inflate the bladder to fold down the bead apex rubber of the bead core assembly so that the bead apex rubber adheres to the central portion of the swelled carcass assembly.

4. The apparatus for building a green tire according to claim 3, wherein
the shaping drum unit is made up of a pair of concentric drums rotatable in sync and movable in the axial direction to get close to each other or away from each other, and
each of the concentric drums and one of the bead locks on the same side in the axial direction are supported by an axially-slidable body (13) so that the drum and bead lock supported thereby can move together.
